(19) United States
(12) Patent Application Publication
(10) Pub. No.: US 2007/0078710 A1
(43) Pub. Date: Apr. 5, 2007

(54) System and method for providing unique and immediately redeemable incentive vouchers to a customer to encourage transactions with a business entity

(75) Inventor: Neil Carmichael Bender II, Wilmington, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Image Products, Inc.

(21) Appl. No.: 11/243,050

(22) Filed: Oct. 4, 2005

(51) Int. Cl. G06Q 30/00

(52) U.S. Cl. 705/14

(57) ABSTRACT

The present invention provides unique and immediately redeemable incentive vouchers to a customer when specified transactions occur between the customer and a business entity so as to encourage the customer to initiate additional transactions with the business entity. More specifically, the present invention provides a tiered incentive program that issues vouchers having a minimum redemption value and unique identifiers that may be redeemed for a reward. The present invention also provides steps for administering the incentive method of the present invention on behalf of a business entity so as to reduce the burden of tracking, issuing, and redeeming incentives that may be issued to the customers.

### BACKGROUND OF THE INVENTION

1. Field of the Invention

The present invention relates to the field of incentive systems for providing premiums to customers to reward and encourage customer transactions with a business entity such as a bank, insurance company, or other business.

2. Description of Related Art

Many companies provide incentives to customers in return for their business. Commonly used incentive programs may include: frequent flier miles; “points” that may be earned in return for money spent by a consumer at a particular retailer and/or service provider; and “cash back” programs wherein businesses provide cash incentives to customers that may be proportional to purchase value. In addition, some business entities, such as banks, mortgage companies, automobile dealerships, and others, may provide rewards, gifts, and/or premiums to encourage customers to visit a business location and/or engage in a business transaction with the business entity. In many cases, however, such rewards, gifts, and/or premiums are pre-selected by the marketing personnel of the business entity for a one-time and/or limited-time promotion, such that if potential customers are not enticed by the reward that is offered, they are often not encouraged to visit and/or engage in a transaction.

Furthermore, while conventional incentive systems for encouraging transactions between customers and business entities may provide a potential and/or current customer with incentives such as redeemable “points,” “miles,” and/or “cash back” that may be incrementally earned, such incentives often do not provide the customer with the instant ability to redeem the incentive for a selected reward. More specifically, conventional incentive methods fail to provide unique and/or instantly redeemable incentives to customers in return for a transaction, such that the customer may be encouraged to engage in the transaction with the business entity. For example, if a business entity only offers generic “points” in return for a given transaction, a customer may be less likely to be encouraged to engage in the transaction because more than one transaction may be required to accumulate sufficient “points” to redeem for a reward that has value to the customer. Alternatively, while some business entities, such as banks, provide gifts and/or rewards directly in return for transactions (such as opening a checking account, for example), these instantaneous rewards may not be enticing to all potential customers, as only one or a limited variety of gifts may be practically offered by the business entity.

Conventional incentive systems thus lack the ability to blend the flexibility of a “points-based” incentive system (that may allow a potential customer to select a reward and/or gift that is most likely to encourage a transaction) with the “instant gratification” aspect of certain “gift-based” incentive system (wherein a selected “free gift” is offered to the potential customer in return for engaging in a business transaction). Furthermore, certain “gift-based” conventional incentive systems are often purchased directly by a business entity such that the purchased “gifts” must be stored and distributed to potential customers directly by the business entity. This limitation of conventional incentive systems often limits the capability of the business entity to offer an array of potential gifts and/or rewards from which a potential customer might choose in return for engaging in a selected transaction. Furthermore, conventional incentive systems also must be administered directly by the business entity. For example, a business entity, when offering promotional rewards and/or incentives, may be charged not only with storing the rewards and/or gifts, but also shipping, distributing, and providing customer service with respect to the rewards. Thus, the use of conventional incentive programs may be labor-intensive and require special training and/or additional employee support.

The limitations in conventional incentive systems may also create a burden on the systems of a business entity that seeks to encourage transactions with a group of potential customers. For example, the business entity may be required to display (via a specialized internet web page, for example) the rewards that may be available in return for accumulating incentive “points.” Because such “points” are often proportional to dollar amounts spent at the business entity, the business entity may often be required to expend computing power to calculate and store incentive “points” in uneven denominations or unusable point totals. For example, after redeeming some portion of accumulated incentive “points,” a customer may be left with an unusable point total that is insufficient to purchase and/or exchange for any reward.

Therefore, there exists a need for an improved incentive method and/or computer program product to solve the technical problems outlined above that are associated with conventional incentive systems. More particularly, there exists a need for a method capable of providing instant incentives, having an immediately redeemable and discrete value to a customer, in exchange for engaging in a given transaction. There also exists a need for an incentive method that provides flexibility to the potential customers to redeem the instant incentives for a variety of different rewards, arranged in value tiers, corresponding to the discrete redemption value of an incentive voucher. Furthermore, there exists a need for a turn-key incentive method that reduces the burden on a business entity by: providing a display of available rewards, providing third-party administration of incentive vouchers, detecting transactions (and the assigned values thereof) with the business entity, providing customer service for shipping and/or distributing the rewards, and/or providing other operational support for the incentive system.

### BRIEF SUMMARY OF THE INVENTION

The needs outlined above are met by the present invention which, in various embodiments, provides an incentive method and/or computer program product that overcomes many of the technical problems discussed above, as well other technical problems, with regard to the encouragement of transactions between a customer and a business entity, wherein each of the transactions has an assigned value. According to one embodiment of the present invention, the method and/or computer program product comprises steps for: detecting the transaction between at least one of the plurality of customers and the business entity; and issuing a voucher to the at least one customer in response to the detected transaction. According to some embodiments, the voucher may be issued with a unique indicia and a redemption value corresponding to the assigned value of the transaction. In some embodiments of the present invention, the voucher may also be issued with an expiration date. Furthermore, the voucher may be instantly and singularly redeemable, according to the unique indicia (such as a serial number and/or printed redemption value), in exchange for a reward corresponding to the redemption value of the voucher. Thus, the instantly redeemable and unique voucher may encourage the customer to engage in additional transactions with the business entity.

Additional method and/or computer program product embodiments of the present invention may further comprise steps for receiving the voucher from the customer (at a customer service center and/or via an internet web page interface, for example) and issuing the reward in exchange for the voucher. According to various embodiments, the issuing step may comprise, for example, shipping the reward directly to the customer. Other method and/or computer program embodiments of the present invention may also comprise receiving the voucher from the at least one customer and adding the redemption value of the voucher to an account balance corresponding to the customer such that the account balance may accumulate the redemption value of the voucher. Thus, according to some embodiments, a computer program product may add, track, and/or store redemption value information for a plurality of vouchers on behalf of a customer such that the customer may “save” the discrete redemption value of several relatively low-value vouchers to accumulate an account balance that may allow the customer to redeem the account balance for a higher-value reward. For example, in some embodiments, the method and/or computer program embodiment of the present invention may also comprise steps for: receiving a redemption request from the customer, wherein the redemption request may correspond to a portion of the account balance; and issuing the reward in return for the portion of the account balance.

Various method and/or computer program embodiments of the present invention may also serve to perform administrative and/or service functions with regard to a customer incentive program. For example, some embodiments of the present invention may further comprise presenting the rewards to the customer via a display (such as an internet web page and/or other electronic display) for displaying the reward in a redemption category corresponding to a value of the reward. In some embodiments, the rewards may be arranged and displayed in tiered redemption categories such that as a customer is issued incentive vouchers having a sufficient redemption value, the customer may redeem the incentive voucher for a reward in one or more of the displayed redemption categories. In addition, some method and/or computer program products of the present invention may also comprise shipping the reward to the customer on behalf of the business entity, such that the business entity need not warehouse and/or administer the shipping and/or issuing functions that accompany the customer's redemption of an incentive voucher. Furthermore, some method and/or computer program product embodiments of the present invention may also comprise additional customer service steps. For example, one embodiment may further comprise contacting the customer to confirm the reward issuing and shipping steps.

Thus the methods and computer program products for encouraging transactions between a customer and a business entity, as described in the embodiments of the present invention, provide many advantages that may include, but are not limited to: providing a tiered incentive and reward system that provides a customer with an instantly redeemable incentive for engaging in a business transaction; providing an incentive voucher that may be selectively redeemed for an instant reward and/or stored in a customer account so as to accumulate incentive value that may be later exchanged for a “higher-tier” reward; providing incentive vouchers having an instantly redeemable value and individualized indicia (such as serial numbers) such that the customer receives a valuable incentive for even low-value transaction types; and providing an incentive method that is turn-key such that a business entity may focus on their business and/or customer service while the incentive method is administered by a third party that may track the vouchers, present the rewards, and handle customer service issues related to the incentive program.

These advantages and others that will be evident to those skilled in the art are provided in the methods and computer program products of the present invention. Importantly, all of these advantages allow a business entity to more effectively and efficiently encourage customers to engage in selected transactions with the business entity. Since the issued incentive vouchers have an instantly redeemable value and unique indicia, and still allow the customer to choose what rewards might be most desirable, the present invention provides a more effective incentive for encouraging customers to engage in selected transactions with the business entity.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 shows a flow chart of a method according to one embodiment of the present invention including the steps of detecting a transaction and issuing a redeemable voucher in response to the detected transaction.

FIG. 2 shows a flow chart of a method according to one embodiment of the present invention including steps for receiving the voucher from a customer and issuing a reward in exchange for the voucher.

FIG. 3 shows a flow chart of a method according to one embodiment of the present invention including steps for receiving the voucher from a customer and adding the value of the voucher to an account balance.

FIG. 4 shows a flow chart of a method according to one embodiment of the present invention including steps for receiving a redemption request from a customer and issuing a reward in return for a portion of the account balance.

FIG. 5 shows a flow chart of a method according to one embodiment of the present invention including a step for displaying a reward in a redemption category corresponding to a value of the reward.

FIG. 6 shows a flow chart of a method according to one embodiment of the present invention including steps for shipping and confirming the issuance of the reward to the customer.

FIG. 7 shows a display according to one embodiment of the present invention wherein a customer may view options for redeeming and/or adding vouchers to an account balance.

FIG. 8 shows a display according to one embodiment of the present invention wherein a customer may add one or more vouchers, and their corresponding redemption vouchers, to an account balance.

FIG. 9 shows a display according to one embodiment of the present invention for displaying the reward in a redemption category corresponding to a value of the reward.

FIG. 10 shows one example of a voucher that may be issued according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. The methods and computer program products of the present invention are described in a banking and health insurance company incentives environment. It must be understood that this is only one example of the use of the present invention. Specifically, the methods and computer program products of the present invention can be adapted to any number of business entity types (engaging in a number of different transaction types with customers). For example, the present invention may be used to encourage transactions including, but not limited to: loan originations with mortgage companies; initiation of cellular and/or land telephone service with a telecommunications company; transactions via any number of “e-businesses” such as, for example, internet-based payment companies and/or auction sites; and the purchase and/or financing of a vehicle.

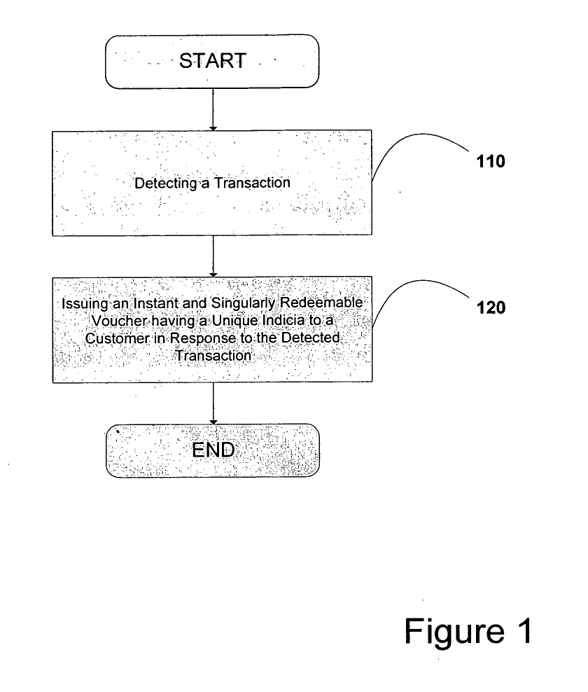

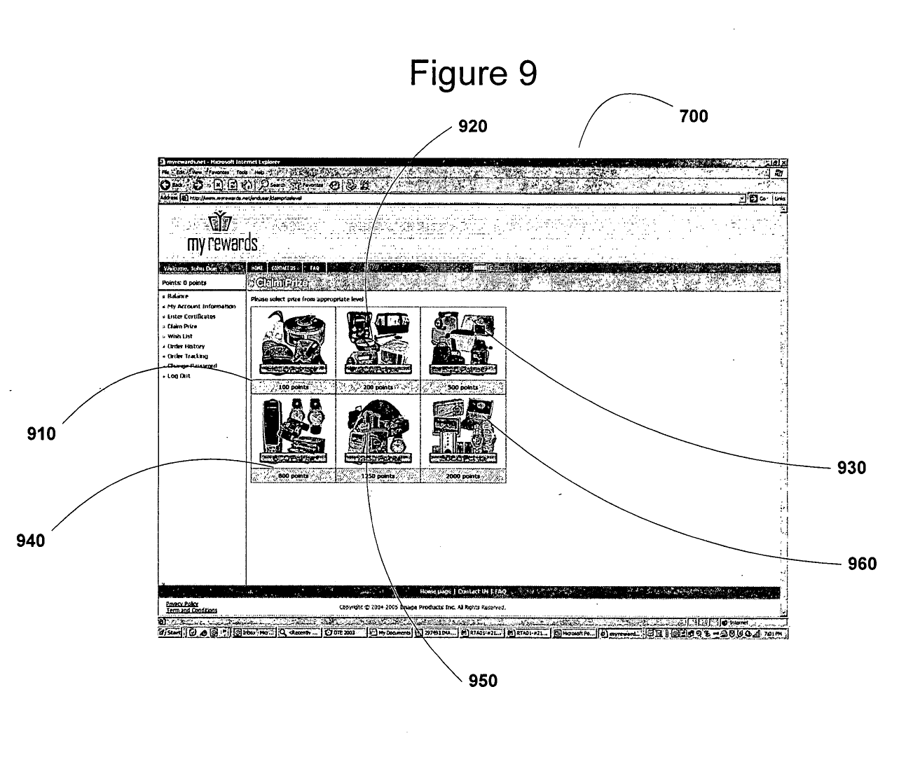

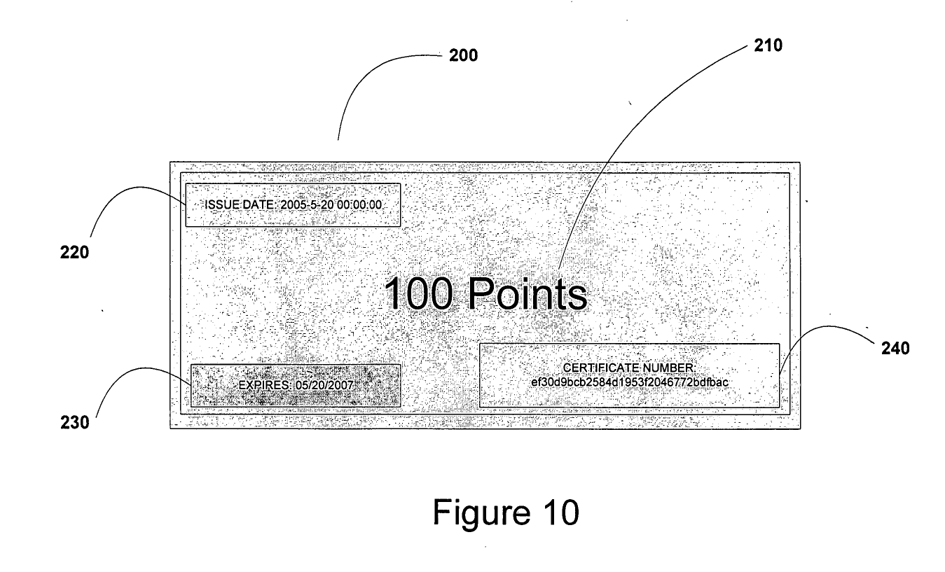

FIG. 1 shows a flow chart depicting a method according to one embodiment of the present invention for encouraging transactions between a customer and a business entity. The method may comprise, for example, step 110 for detecting a transaction between at least one of a plurality of customers and the business entity; and step 120 for issuing a voucher 200 (see FIG. 10, for example) to the at least one customer in response to the detected transaction. According to some method embodiments, as shown in FIG. 10, the voucher 200 may have a unique indicia 240 (such as a serial number and/or certificate number 240) and a redemption value 210 corresponding to the value of the at least one transaction. In some other embodiments, step 120 may also comprise issuing a voucher 200 having a date of issue 220 and/or an expiration date 230. The voucher 200 issued by some embodiments of the present invention, may be instantly and singularly redeemable (via an internet website or display (see FIG. 9, for example), according to the unique indicia 240, in exchange for a reward corresponding to the redemption value 210 of the voucher 200. Thus, the method embodiments of the present invention may encourage the at least one customer to engage in additional transactions with the business entity in order to gain additional vouchers 200 that may be instantly redeemable for one or more rewards.

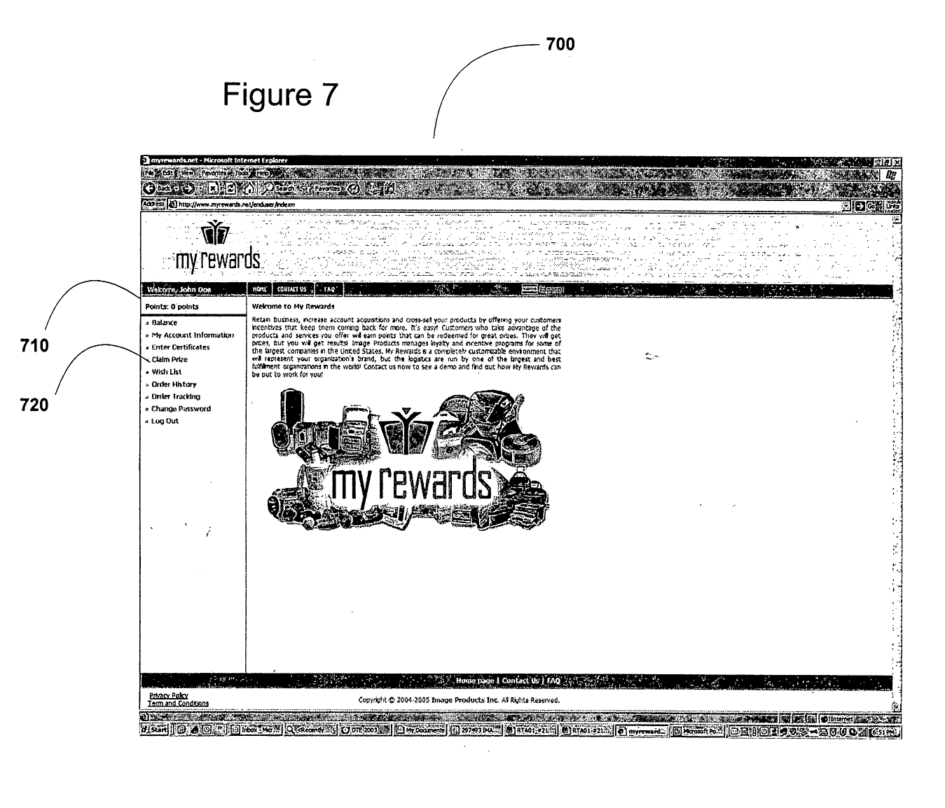

The detecting step 110 may comprise in one embodiment, for example, monitoring a business entity internet website for transaction activity between a customer (which may be identified by a unique customer identifier, such as a customer identification number, password, or other identification) and the business entity. According to some embodiments, the detecting step 110 may be performed by a computer device in communication via wired and/or wireless networks (such as the internet) with a computer device operated by the business entity. Furthermore, in other embodiments, the detecting step 110 may be performed by an individual tasked with monitoring one or more business entities for transactions having an assigned value that may trigger the issuing step 120. In addition, the issuing step 120 may comprise issuing the voucher 200 via various methods, which may include, but are not limited to: issuing the voucher 200 via an electronic mail message; printing a paper copy of the voucher 200 that may be given directly and/or mailed to the customer; displaying the voucher 200 to a customer via a display screen (see FIG. 7, generally, showing a display 700 for displaying voucher 200 and/or other incentive method information to a customer); and other issuing methods. Furthermore, the issuing step 120 may also comprise issuing a voucher 200 to a computer device operated by the business entity (via, for example, a wired and/or wireless network (such as the internet)) such that upon detecting (step 110) a qualifying transaction, the issuing step 120 may send a voucher 200 via electronic mail and/or via facsimile or other method, directly to the business entity such that a representative and/or employee of the business entity may present the customer with the voucher 200 at the physical location of the transaction (such as at the business entity's offices and/or storefront). According to some embodiments of the present invention, such an instantaneous award of a voucher 200 having a redemption value 210 may encourage the customer to engage in further qualifying transactions in the hope of earning more instantly-redeemable vouchers 200 that may be redeemed for one or more of a wide selection of reward items (as described in further detail below).

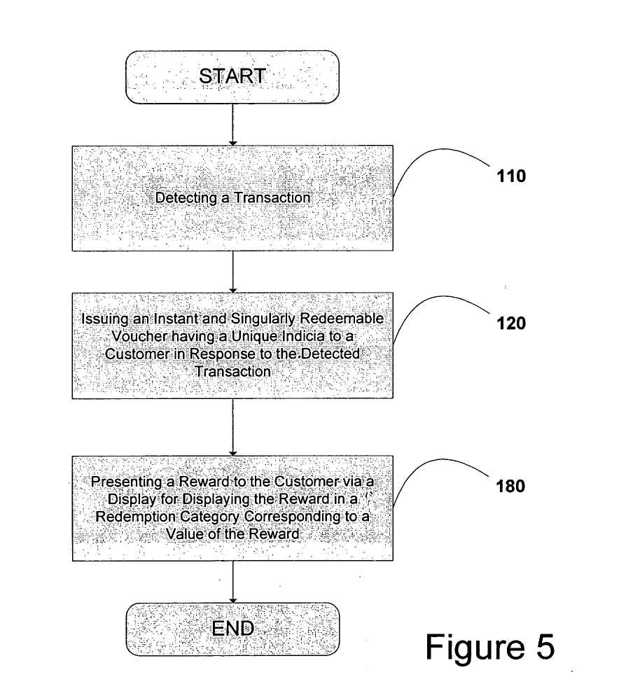

In some method embodiments, the value of the qualifying transaction may be pre-assigned by the business entity such that the issuing step 120 may comprise issuing a voucher 200 having a greater redemption value 240 in return for detected transactions that result in greater profit and/or a more desirable outcome for the business entity. For example, in embodiments where the business entity is a bank, the bank may assign transaction values to various banking transactions such as opening a checking account, and/or applying for a mortgage loan. According to some embodiments, the issuing step 120 may comprise issuing a voucher 200 having a redemption value 210 of 100 points, for example, when a customer opens a new checking account. In another example, the issuing step 120 may comprise issuing a voucher 200 having a redemption value 210 of 500 points, for example, when a customer applies for and/or closes on a mortgage. Thus, the business entity may encourage additional transactions and/or transactions that may be more profitable by assigning values to the transaction types that may be detected in step 110 and issuing vouchers 200 in step 120 that have redemption values 210 that are proportional to the profit and/or desirability of the transaction types detected. As described generally above, the voucher 200 may be instantly and singularly redeemable, according to the unique indicia 240, in exchange for a reward corresponding to the redemption value 210 of the voucher, so as to encourage the at least one customer to engage in additional transactions with the business entity. For example, the bank customer described above may be able to redeem the 100 point voucher 200 immediately for one of the rewards that may be displayed (see step 180, FIG. 5, and the display 700 of FIG. 9) in a 100 point reward category 910.

According to other method embodiments of the present invention, the method may further comprise a separate step for assigning a value to each of at least one transaction between the customer and the business entity. Thus a third party responsible for performing the steps of the present invention may bring specialized marketing expertise to bear in situations where the business entity may lack the marketing savvy and/or market data to appropriately assign values to transactions and corresponding redemption values 210 of vouchers 200 that may be issued in response to the detection (step 110) of such transactions. For example, a business entity such as a bank, may wish to offer new services (such as brokerage accounts) that may result in specialized transaction types (such as buy/sell orders) for which the bank may have no historical data as to transaction frequency and/or revenue realized per transaction. Thus, the method steps of the present invention may include steps for assigning a transaction value to one or more transaction types in order to appropriately incentivize the desired transactions using vouchers 200 and corresponding reward types having commensurate and/or proportional value.

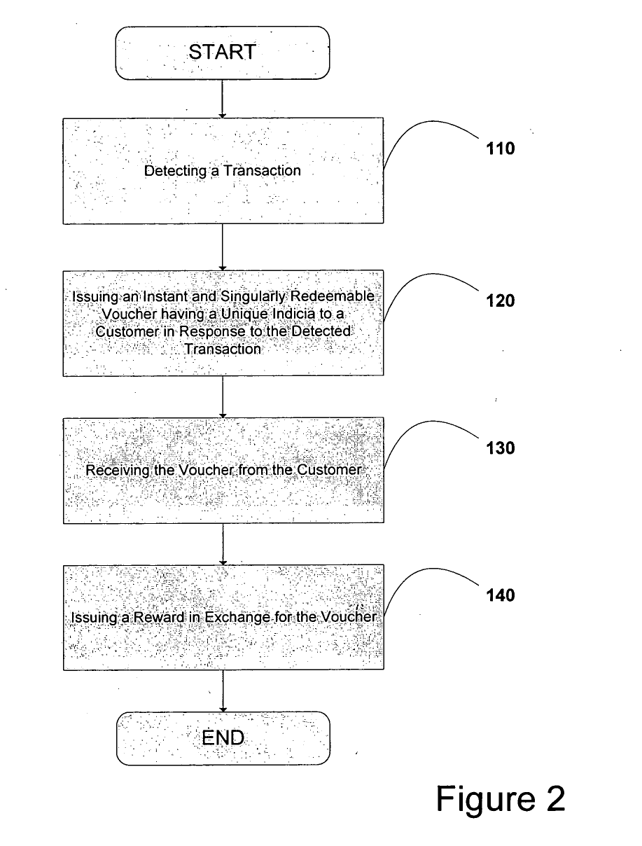

While the examples above are used to encourage transactions having a direct monetary value to the business entity, the method of the present invention may also be used to encourage other types of transactions between customers and a business entity. For example, the method of the present invention may also be used by health insurance companies to encouraging health-conscious activity by its clients by detecting “transactions” such as the reporting of regular exercise activity, the reporting of a preventative exam and/or “wellness visit” to a health-care provider, the reporting of healthy eating habits, and/or other health-conscious behaviors that may, in sum, be beneficial to both the insured customers of the insurance company (by encouraging healthy habits) and to the insurer (by reducing payouts required to treat health problems that may be prevented by positive eating and exercise habits). According to one embodiment, the detecting step 110 of the present invention may comprise detecting the reporting (via the health insurance company's internet website, electronic kiosk, and/or an electronic mail message) of a particular customer's exercise program over the course of a month. In response, the method may comprise issuing 120 a voucher 200 having a redemption value 240 of, for example, 100 points, that may be redeemed instantly for a reward that may encourage further exercise, such as, for example, sports equipment displayed in the 100 point redemption category (see element 910, FIG. 9). The detecting step 110 may also detect the customer's reporting of a significant weight loss and/or smoking cessation, which may result in the issuance (step 120) of a voucher having a larger redemption value 240 (commensurate with the long-term benefits of the lifestyle change) that may be instantly redeemed for a more significant reward (i.e., a 500 point redemption value 240, that may be redeemed for a digital camera or other electronic equipment listed in the 500 point redemption category (see element 930, FIG. 9). Other examples of voucher 200 redemption are described in further detail below with respect to the reward issuing steps 140, 170 (shown generally in FIGS. 2, 4, 6, and 9).

FIG. 2 shows another exemplary method embodiment of the present invention, further comprising a receiving step 130 for receiving the voucher 200 from the customer, and an issuing step 140 for issuing a reward in exchange for the voucher. According to one embodiment (shown generally in FIG. 5) of the present invention, the method of the present invention may also comprise a presenting step 180, for presenting a reward to the customer via a display 700 (see FIG. 9, for example, depicting an internet webpage that may be accessed by a customer according to one embodiment of the present invention, for viewing rewards that may be obtained by redeeming unique vouchers 200 issued via step 120 of the present invention).

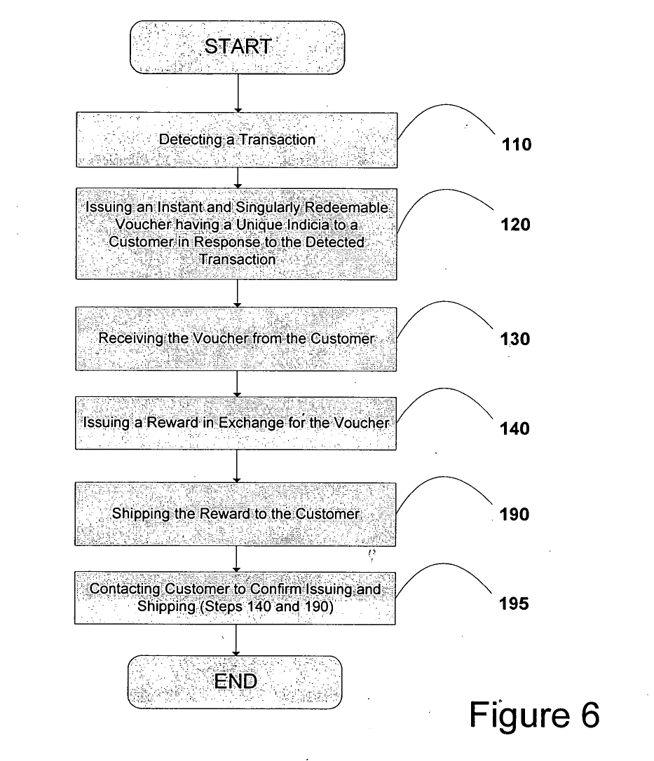

The display 700 may, in some embodiments (as shown generally in FIG. 9, present the reward to the customer in a redemption category (see elements 910-960) corresponding to the value of the reward. Thus, according to some embodiments of the present invention, the customer may access the various reward redemption categories via an internet website configured to present the display 700 shown generally in FIG. 9 such that the customer may instantly redeem an issued voucher 200 (having a specific redemption value 210) for a reward in one of the categories 910-960 shown in the display. For example, if the customer has been issued a voucher 200 having a redemption value 210 of 500 points, the customer may choose to instantly redeem the voucher 200 for one of the items listed within the 500 point redemption category 930 in the display. According to some method and computer program product embodiments of the present invention, the display 700 shown generally in FIG. 9 may also display the redemption categories 910-960 as interactive graphics that may be selected (i.e., by the click of a mouse), causing the display 700 to update to a detailed list and/or description of reward items that the customer may choose to be issued according to step 130 of the method of the present invention. According to various embodiments of the present invention, the issuing step 140 may comprise initiating a shipping step 190 (see FIG. 6, for example) and/or a contacting step 195 (see also, FIG. 6, for example). In addition, according to some embodiments, the issuing step 140 may also initiate (either automatically via computer program product embodiments of the present invention, or via substantially manual methods, such as the generation of a warehouse “pick sheet” or order sheet) a step for notifying a warehouse and/or third-party logistic service of the customer's shipping address and/or other information that may assist in the issuance (step 140) of the reward in return for the voucher 200 (step 130). For example, once the customer has selected a reward, entered voucher information (such as the unique indicia 240) and initiated the receiving step 130, methods of the present invention, as part of the issuing step 140, may comprise automatically notifying a third-party (responsible for storing and/or shipping the various rewards) that the selected reward should be shipped to the customer. Such a notification may be performed in an automated manner according to some computer program embodiments of the present invention as part of the issuing 140, shipping 190, and/or contacting 195 steps.

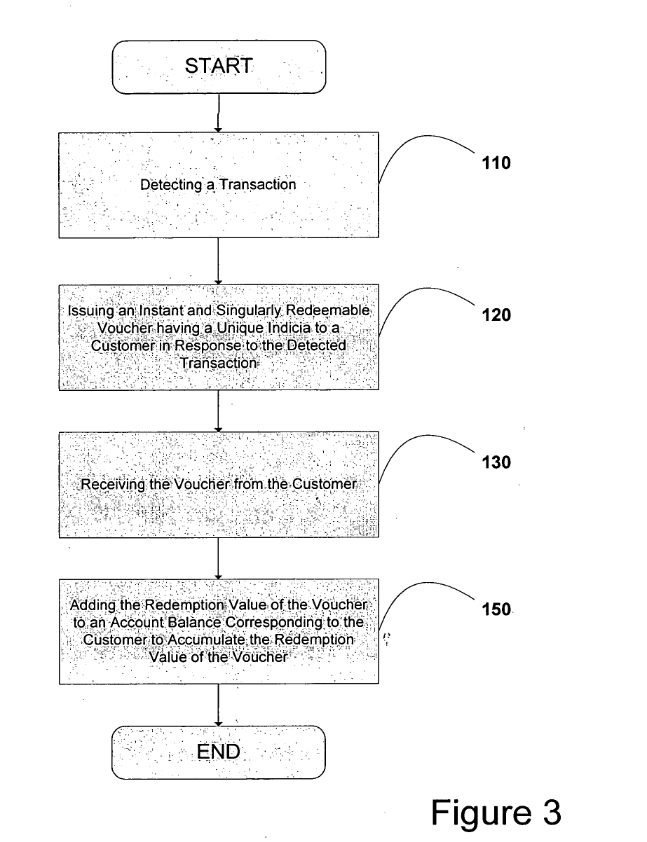

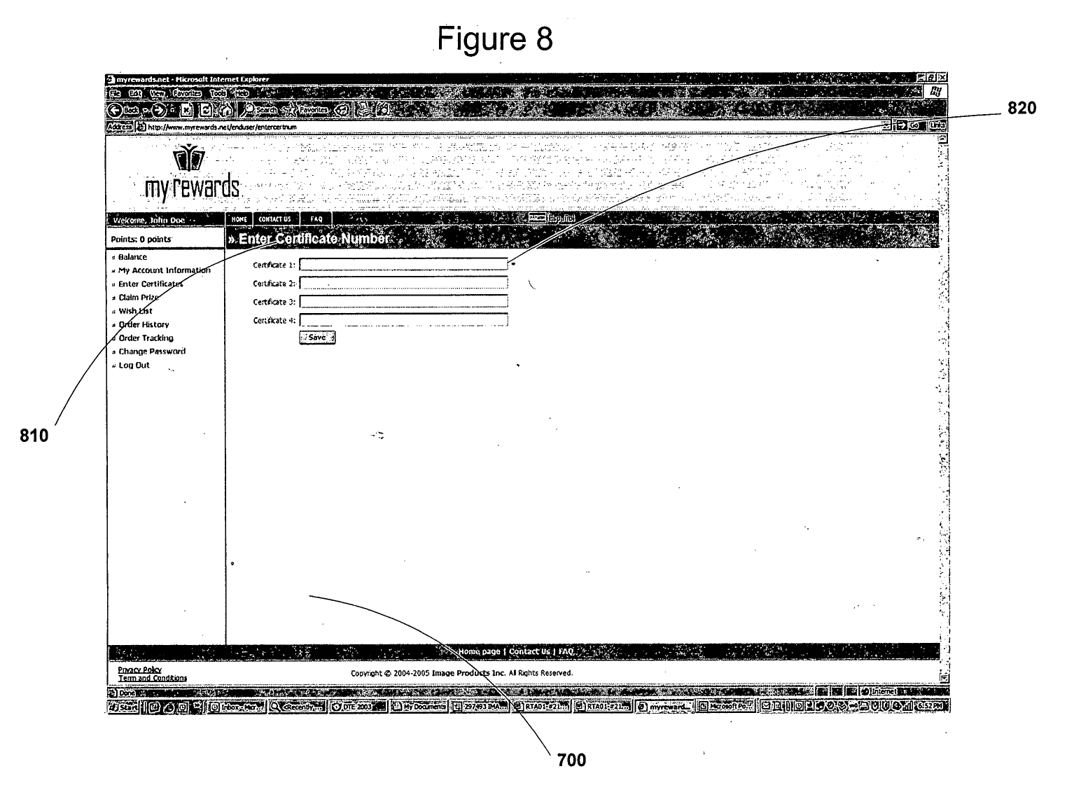

The method of the present invention also provides additional alternate embodiments wherein a customer may choose to save multiple vouchers 200 and accumulate the redemption values 210 of the multiple vouchers in an account balance that may be received (in its entirety, or in discrete portions, see steps 160 and 170 described below) and/or redeemed for rewards having a greater value than the redemption value 210 of any one voucher 200. For example, as shown in FIG. 3, the method and computer program embodiments of the present invention may further comprise step 130 for receiving the voucher 200 from the customer, and step 150 for adding the redemption value 210 of the voucher 200 to an account balance corresponding to the customer such that the account balance may accumulate the redemption value 210 of the voucher 200. According to some method and/or computer program product embodiments of the present invention, the receiving step 130 (which may also precede the issuing step 140 listed above in FIG. 2) may be performed via an internet website and/or computer display 700 (as shown in FIG. 8, for example) comprising a voucher input prompt 810 and a voucher input field 820 such that the customer may enter one or more vouchers 200 that may be received (according to step 130) and accumulated (see step 150) in an account balance that may be maintained according to various embodiments of the present invention, in a computer device, such as a server and/or personal computer that may be selectively accessed by the customers via an internet portal and/or via a computer display 700 (as shown generally in FIG. 7) which may be provided to facilitate the method steps of the present invention. According to other method embodiments of the present invention, steps 130 (the voucher 200 receiving step) and 150 (the redemption value 210 adding step) may also be performed by substantially manual and/or semi-manual methods. For example, according to some embodiments, step 130 and/or step 150 of the present invention may be performed by providing a facility which may include, but is not limited to: a customer service center, a substantially automated kiosk, and/or other input area that may be operated by the business entity and/or a third party responsible for performing the method steps of the present invention. Thus, a customer may choose to redeem and/or input the unique vouchers 200 at such a facility in lieu of and/or in addition to redeeming the vouchers via an internet website (as shown generally in FIG. 8, for example).

Thus, according to one example of the steps receiving 130 and adding 150 steps of the present invention, the method may comprise receiving four unique vouchers 200, each having a redemption value 210 of 200 points (which may have been issued to the customer (in step 120, for example) in return for engaging in four separate transactions) and adding 150 the redemption values of the unique vouchers 200 to accumulate an account balance of 800 points. Thus, steps 130 and 150 of the present invention may also enable the customer to select and redeem the account balance for a reward in the 800 point redemption category (see element 940 of FIG. 9) instead of 4 individual rewards in the 200 point reward category (see element 920 of FIG. 9). According to some embodiments, however, as discussed above, the voucher issuing step 120 may also comprise issuing vouchers 200 having an expiration date 230. Thus, the method embodiments of the present invention may also be capable of automatically determining when one or more of the unique vouchers have expired and adjusting the account balance accordingly. For example, according to some embodiments, the methods and computer program embodiments of the present invention may be capable of determining the expiration date 230 of a particular unique voucher 200 via the unique indicia 240 of the voucher and automatically removing the redemption value of the voucher 200 from the account balance upon an expiration date 230 of the voucher 200.

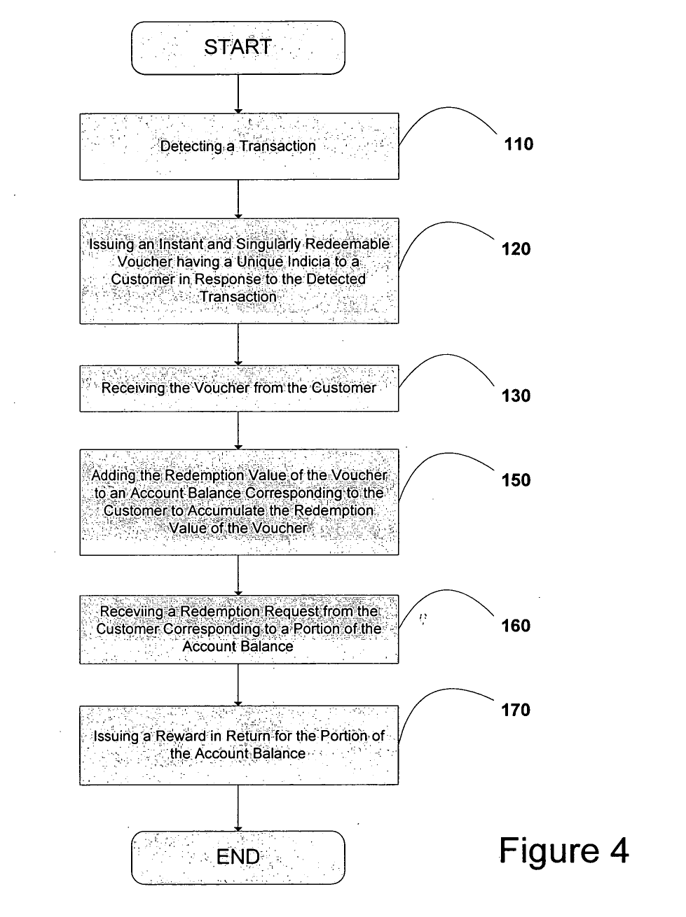

FIG. 4 shows a flow chart depicting another alternate method embodiment of the present invention further comprising step 160 for receiving a redemption request from the customer (the redemption request corresponding to a portion of the account balance accumulated and/or adjusted in step 150, for example), and step 170 for issuing the reward in return for the portion of the account balance. As described above with respect to issuing step 140, issuing step 170 may also comprise initiating a shipping step 190 (see FIG. 6, for example) and/or a shipping and issuing confirmation step 195 (see also, FIG. 6, for example). In addition, according to some embodiments, the issuing step 170 may also initiate (either automatically via electronic notification and/or computer program product embodiments of the present invention, or via substantially manual methods, such as the generation of a warehouse “pick sheet” or order) a step for notifying a warehouse and/or third-party logistic service of the customer's shipping address and/or other information that may assist in the issuance (step 170) of the reward in return for the redemption of at least a portion of the accumulated account balance.

Various method and computer program product embodiments of the present invention may also provide a “turn-key” incentive program for a business entity (such as a bank, for example) to encourage one or more transactions between a customer and the business entity. For example, in some embodiment, the presenting step 180 (see FIG. 5) may comprise presenting the rewards to a customer via an internet website and/or other visual display 700 that includes a logo, color scheme, background, trademarks, and/or trade dress that represents the business entity. Similarly, the voucher issuing step 120 may also comprise issuing a voucher 120 that may be printed and/or displayed with a logo, color scheme, background, trademarks, and/or trade dress that is representative of the business entity. Furthermore, according to some embodiments some or all of the rewards issued (see steps 140 and 170, for example) may also be imprinted directly with and/or shipped (see step 190, for example) in packing material including a logo, color scheme, background, trademarks, and/or trade dress representing the business entity. Thus, the methods of the present invention may be performed by a third party provider on behalf of the business entity such that the customer may be exposed only to the business entity (instead of the third-party provider) and also such that the business entity need not be involved with the operation and/or administration of the methods and/or computer program products of the present invention.

For example, some method and/or computer program product embodiments of the present invention (shown generally in FIG. 6) may comprise shipping the reward to the customer on behalf of the business entity (step 190). Furthermore, according to some embodiments, as described generally above, the method of the present invention may also comprise (as part of the issuing steps 140, 170 and/or the shipping step 190) notifying a logistic service provider (such as a warehousing and/or shipping entity) when a voucher 200 and/or some portion of an account balance has been received (step 130, for example) and/or redeemed by a customer. Such a notification may include, but is not limited to: the identification of a specific reward, the customer identification and/or shipping address, special shipping instructions, and/or the business entity on whose behalf the reward is being shipped. Thus, the operator performing the steps of the present invention may select packing materials, literature, and/or specific reward types that correspond to a given business entity.

In addition, some embodiments of the present invention may also comprise step 195 (see FIG. 6) for contacting the customer to confirm the issuing (140, 170) and shipping (190) steps. For example, the methods and/or computer program products of the present invention may prompt customer service personnel to provide a follow-up telephone call to the customer to ensure that the appropriate reward was received by the customer, that the voucher 200 was correctly received, and/or that the shipping step 190 occurred within a promised and/or expected time frame. Furthermore, according to some other embodiments, the contacting step 195 may also comprise generating an automated and/or semi-automated message (which may include, for example, an electronic mail message) to the customer to confirm accuracy and promptness of the issuing (140, 170) and shipping 190 steps of the present invention.

In addition to providing apparatus and methods, the present invention also provides computer program products for performing the operations described above. The computer program products have a computer readable storage medium having computer readable program code means embodied in the medium. The computer readable storage medium may be part of a storage device and may implement the computer readable program code means to perform the above discussed operations.

In this regard, FIGS. 1-6 are block diagram illustrations of methods and program products according to the invention. It will be understood that each block or step of the block diagram and combinations of blocks in the block diagram can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for encouraging transactions between a customer and a business entity, each of at least one transaction having an assigned value, the method comprising:
detecting the at least one transaction between at least one of the plurality of customers and the business entity;
issuing a voucher to the at least one customer in response to the detected at least one transaction, the voucher having a unique indicia and a redemption value corresponding to the value of the at least one transaction, the voucher being instantly and singularly redeemable, according to the unique indicia, in exchange for a reward corresponding to the redemption value of the voucher, so as to encourage the at least one customer to engage in additional transactions with the business entity.

2. A method according to claim 1, further comprising:
receiving the voucher from the at least one customer; and
issuing the reward in exchange for the voucher.

3. A method according to claim 1, further comprising:
receiving the voucher from the at least one customer; and
adding the redemption value of the voucher to an account balance corresponding to the customer such that the account balance may accumulate the redemption value of the voucher.

4. A method according to claim 3, further comprising removing the redemption value of the voucher from the account balance upon an expiration date of the voucher.

5. A method according to claim 3, further comprising:
receiving a redemption request from the customer, the redemption request corresponding to a portion of the account balance; and
issuing the reward in return for the portion of the account balance.

6. A method according to claim 1, further comprising presenting the reward to the customer via a display for displaying the reward in a redemption category corresponding to a value of the reward.

7. A method according to claim 2, further comprising shipping the reward to the customer on behalf of the business entity.

8. A method according to claim 7, further comprising contacting the customer to confirm the issuing and shipping steps.

9. A method according to claim 1, wherein the issuing step further comprises issuing the voucher with an expiration date.

10. A method for encouraging transactions between a customer and a business entity, the method comprising:
assigning a value to each of at least one transaction between the customer and the business entity;
detecting at least one transaction between at least one of the plurality of customers and the business entity;
issuing a voucher to the at least one customer in response to the detected at least one transaction, the voucher having a unique indicia and a redemption value corresponding to the value of the at least one transaction, the voucher being instantly and singularly redeemable, according to the unique indicia, in exchange for a reward corresponding to the redemption value of the voucher, so as to encourage the at least one customer to engage in additional transactions with the business entity.

11. A method according to claim 10, further comprising:
receiving the voucher from the at least one customer; and
issuing the reward in exchange for the voucher.

12. A method according to claim 10, further comprising:
receiving the voucher from the at least one customer; and
adding the redemption value of the voucher to an account balance corresponding to the customer such that the account balance may accumulate the redemption value of the voucher.

13. A method according to claim 12, further comprising removing the redemption value of the voucher from the account balance upon an expiration date of the voucher.

14. A method according to claim 12, further comprising:
receiving a redemption request from the customer, the redemption request corresponding to a portion of the account balance; and
issuing the reward in return for the portion of the account balance.

15. A method according to claim 10, further comprising presenting the reward to the customer via a display for displaying the reward in a redemption category corresponding to a value of the reward.

16. A method according to claim 10, further comprising shipping the reward to the customer on behalf of the business entity.

17. A method according to claim 16, further comprising contacting the customer to confirm the issuing and shipping steps.

18. A method according to claim 10, wherein the issuing step further comprises issuing the voucher with an expiration date.

19. A computer program product for encouraging transactions between a customer and a business entity, each of at least one transaction having an assigned value, the computer program product comprising a computer-readable storage medium having computer-readable program code instructions stored therein comprising:
first computer instruction means for detecting at least one transaction between at least one of the plurality of customers and the business entity;
second computer instruction means for issuing a voucher to the at least one customer in response to the detected at least one transaction, the voucher having a unique indicia and a redemption value corresponding to the value of the at least one transaction, the voucher being instantly and singularly redeemable, according to the unique indicia, in exchange for a reward corresponding to the redemption value of the voucher, so as to encourage the at least one customer to engage in additional transactions with the business entity.

20. A computer program product according to claim 19, further comprising:
third computer instruction means for receiving the voucher from the at least one customer; and
fourth computer instruction means for issuing the reward in exchange for the voucher.

21. A computer program product according to claim 19, further comprising:
fifth computer instruction means for receiving the voucher from the at least one customer; and
sixth computer instruction means for adding the redemption value of the voucher to an account balance corresponding to the customer such that the account balance may accumulate the redemption value of the voucher.

22. A computer program product according to claim 21, further comprising seventh computer instruction means for removing the redemption value of the voucher from the account balance upon an expiration date of the voucher.

23. A computer program product according to claim 21, further comprising:
eighth computer instruction means for receiving a redemption request from the customer, the redemption request corresponding to a portion of the account balance; and
ninth computer instruction means for issuing the reward in return for the portion of the account balance.

24. A computer program product according to claim 19, further comprising tenth computer instruction means for presenting the reward to the customer via a display for displaying the reward in a redemption category corresponding to a value of the reward.

25. A computer program product according to claim 20, further comprising eleventh computer instruction means for shipping the reward to the customer on behalf of the business entity.

26. A computer program product according to claim 25, further comprising twelfth computer instruction means for contacting the customer to confirm the issuing and shipping of the reward.

27. A computer program product according to claim 19, wherein the second computer instruction means for issuing further comprises thirteenth computer instruction means for issuing the voucher with an expiration date.
